(19) United States
(12) Patent Application Publication
(10) Pub. No.: US 2007/0229147 A1
(43) Pub. Date: Oct. 4, 2007

(54) Circuit supply voltage control using an error sensor

(75) Inventors: Bruce Doyle, Longmont, CO (US); Manish Kumar, Austin, TX (US); John J. Wuu, Fort Collins, CO (US); Samuel Naffziger, Fort Collins, CO (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/395,475

(22) Filed: Mar. 30, 2006

(51) Int. Cl. G05F 1/10

(52) U.S. Cl. 327/540

(57) ABSTRACT

For one disclosed embodiment, a supply voltage regulator is to control voltage at a first supply node for a circuit. The supply voltage regulator includes one or more first devices to couple the first supply node to a second supply node when the circuit is in a predetermined operational state and includes an error sensor to control the one or more first devices. The supply voltage regulator includes one or more second devices to couple the first supply node to a third supply node when the circuit is in the predetermined operational state. Other embodiments are also disclosed.

### FIELD

Embodiments described herein generally relate to voltage regulation.

### BACKGROUND

One technique to reduce power consumption in an integrated circuit having a static random access memory (SRAM) is to reduce the supply voltage for inactive SRAM cells toward the minimum supply voltage needed for such cells to retain their contents.

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, a block diagram of a regulator to control supply voltage for a circuit using an error sensor;

FIG. 2 illustrates, for one embodiment, a flow diagram to control supply voltage for a circuit using an error sensor;

FIG. 3 illustrates, for one embodiment, circuitry for a regulator to control supply voltage for a circuit using an error sensor;

FIG. 4 illustrates, for one embodiment, an example signal timing diagram for circuitry of FIG. 3;

FIG. 5 illustrates, for another embodiment, circuitry for a regulator to control supply voltage for a circuit using an error sensor; and

FIG. 6 illustrates, for one embodiment, a block diagram of an example system comprising a processor having a cache memory including regulator to control supply voltage for a circuit using an error sensor.

The figures of the drawings are not necessarily drawn to scale.

### DETAILED DESCRIPTION

The following detailed description sets forth example embodiments of apparatuses, methods, and systems relating to circuit supply voltage control using an error sensor. Features, such as structure(s), function(s), and/or characteristic(s) for example, are described with reference to one embodiment as a matter of convenience; various embodiments may be implemented with any suitable one or more described features.

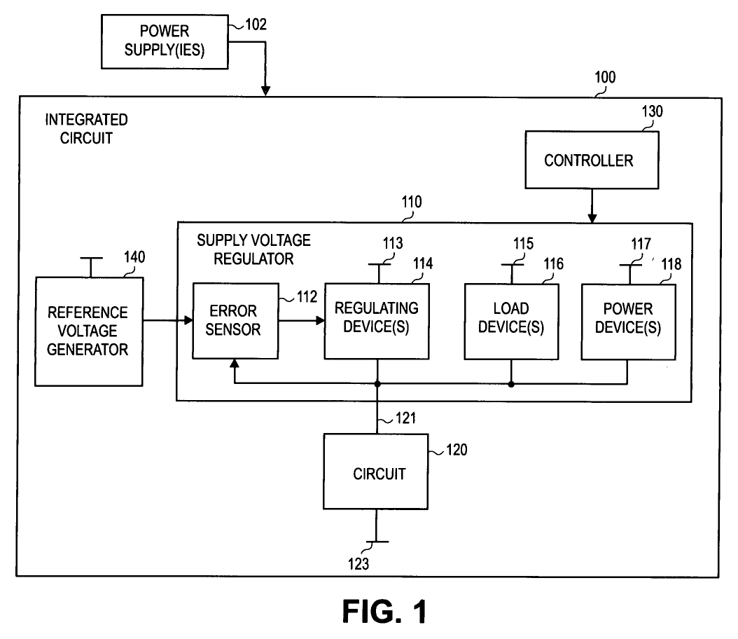

FIG. 1 illustrates, for one embodiment, an integrated circuit 100 having a supply voltage regulator 110 to control supply voltage for a circuit 120 of integrated circuit 100 using an error sensor 112. Supply voltage regulator 110 may be coupled to receive one or more input supply voltages at one or more supply nodes, such as supply nodes 113, 115, and/or 117 for example, and may be coupled to supply a regulated, output supply voltage at a supply node 121 for circuit 120. Circuit 120 may be coupled to supply node 121 and to a supply node 123 to power circuit 120.

Supply voltage regulator 110 for one embodiment may be coupled to receive the same input supply voltage at two or more supply nodes, such as supply nodes 113, 115, and/or 117. Such common supply nodes may be considered the same node.

Circuit 120 for one embodiment may be coupled to receive a supply voltage at supply node 123 and may be coupled to receive at supply node 121 a supply voltage higher than supply voltage at supply node 123. That is, supply voltage regulator 110 may be used to regulate the higher or positive supply for circuit 120. Integrated circuit 100 for one embodiment may be coupled to one or more external power supplies 102 to generate supply voltage(s) at supply nodes 113, 115, and 117. Power supply(ies) 102 for one embodiment may include a battery. Power supply(ies) 102 for one embodiment may include an alternating current to direct current (AC-DC) converter. Power supply(ies) 102 for one embodiment may include a DC-DC converter. Integrated circuit 100 for one embodiment may be coupled to generate positive supply voltage(s) at supply nodes 113, 115, and 117. Integrated circuit 100 for one embodiment may be coupled to any suitable supply voltage source to generate reference supply voltage, such as ground for example, at supply node 123.

Circuit 120 for one embodiment may be coupled to receive a supply voltage at supply node 123 and may be coupled to receive at supply node 121 a supply voltage lower than supply voltage at supply node 123. That is, supply voltage regulator 110 may be used to regulate the lower or negative supply for circuit 120. Integrated circuit 100 for one embodiment may be coupled to power supply(ies) 102 to generate supply voltage at supply node 123. Integrated circuit 100 for one embodiment may be coupled to generate positive supply voltages at supply node 123. Integrated circuit 100 for one embodiment may be coupled to any suitable supply voltage source(s) to generate reference supply voltage(s), such as ground for example, at supply nodes 113, 115, and 117.

Circuit 120 may include any suitable circuitry. Circuit 120 for one embodiment may include one or more memory cells. Circuit 120 for one embodiment may include one or more memory cells for a static random access memory (SRAM).

Although described as having supply voltage regulator 110 to regulate supply voltage at supply node 121 for circuit 120, integrated circuit 100 for one embodiment may also have a supply voltage regulator to regulate supply voltage at supply node 123 for circuit 120. Such a supply voltage regulator may or may not be similar to supply voltage regulator 110.

Supply Voltage Regulator

Supply voltage regulator 110 for one embodiment may control supply voltage at supply node 121 to control supply voltage across circuit 120 and therefore help manage power usage by circuit 120. Supply voltage regulator 110 for one embodiment may control supply voltage at supply node 121 based on an operational state of circuit 120.

Integrated circuit 100 for one embodiment may include a controller 130 coupled to control supply voltage regulator 110 based on an operational state of circuit 120. Controller 130 for one embodiment may monitor circuit 120 to help identify an operational state of circuit 120. Controller 130 for one embodiment may monitor other circuitry of integrated circuit 100, such as circuitry that uses circuit 120 for example, to help identify an operational state of circuit 120. Controller 130 for one embodiment may monitor an operating mode of integrated circuit 100 to help identify an operational state of circuit 120.

Supply voltage regulator 110 for one embodiment may help supply a substantially first target supply voltage at supply node 121 when circuit 120 is in a first predetermined operational state. Supply voltage regulator 110 for one embodiment may control supply voltage at supply node 121 to help supply a reduced supply voltage across circuit 120 when circuit 120 is in the first predetermined operational state. The first predetermined operational state for one embodiment may correspond to an inactive state, for example.

Supply voltage regulator 110 for one embodiment may supply a reduced supply voltage across circuit 120 to help reduce power consumption and/or power dissipation due to current leakage in circuit 120. For one embodiment where circuit 120 includes one or more memory cells, supply voltage regulator 110 for one embodiment may control supply voltage at supply node 121 to reduce supply voltage across circuit 120 to a suitable level still sufficient for such memory cell(s) to retain their content(s). Supply voltage regulator 110 for one embodiment may control supply voltage at supply node 121 to reduce supply voltage across circuit 120 to a level at or near a minimum supply voltage for such memory cell(s) to retain their content(s).

Supply voltage regulator 110 for one embodiment may help supply a substantially second target supply voltage at supply node 121 when circuit 120 is in a second predetermined operational state. The second target supply voltage for one embodiment may be different from the first target supply voltage. Supply voltage regulator 110 for one embodiment may control supply voltage at supply node 121 to help supply an operating supply voltage across circuit 120 when circuit 120 is in the second predetermined operational state. The second predetermined operational state for one embodiment may correspond to an active state, for example.

Supply voltage regulator 110 for one embodiment may control supply voltage at supply node 121 when circuit 120 transitions from the second predetermined operational state to the first predetermined operational state to initially allow supply voltage across circuit 120 to decrease and to then help maintain supply voltage at supply node 121 from exceeding substantially the first target supply voltage. Supply voltage regulator 110 for one embodiment may be considered to help effectively brake supply voltage at supply node 121 from exceeding substantially the first target supply voltage. Supply voltage regulator 110 for one embodiment may control supply voltage at supply node 121 when circuit 120 transitions from the first predetermined operational state to the second predetermined operational state to increase supply voltage across circuit 120.

Supply voltage regulator 110 for one embodiment may transition control of supply voltage at supply node 121 relatively quickly as circuit 120 transitions between operational states. As one example, supply voltage regulator 110 for one embodiment may transition control of supply voltage at supply node 121 relatively quickly as circuit 120 transitions from an inactive state to an active state, allowing circuit 120 to be deactivated and activated as desired with reduced concern for increased latency.

Although described in the context of controlling supply voltage at supply node 121 for an active state and an inactive state, supply voltage regulator 110 may control supply voltage at supply node 121 based on any suitable operational state. Circuit 120 for one embodiment may have multiple active states and/or multiple inactive states, and supply voltage regulator 110 may or may not control supply voltage at supply node 121 differently between different active and/or inactive states. An inactive state of circuit 120 for one embodiment may correspond, for example, to a sleep state of circuit 120, one or more sleep modes for integrated circuit 120, and/or a halt mode for integrated circuit 100.

Supply voltage regulator 110 for one embodiment may include one or more regulating devices 114 to couple supply node 121 to supply node 113 when circuit 120 is in the first predetermined operational state and may include one or more load devices 116 to couple supply node 121 to supply node 115 when circuit 120 is in the first predetermined operational state. Supply voltage regulator 110 for one embodiment may use regulating device(s) 114 and load device(s) 116 to help supply substantially the first target supply voltage at supply node 121 when circuit 120 is in the first predetermined operational state, such as an inactive state for example.

Supply voltage regulator 110 for one embodiment may include error sensor 112 to control regulating device(s) 114 and therefore control supply voltage at supply node 121. Error sensor 112 and regulating device(s) 114 for one embodiment help form a closed loop feedback control system to help supply substantially the first target supply voltage at supply node 121. Error sensor 112 for one embodiment may be coupled to receive supply voltage at supply node 121 and a reference voltage from a reference voltage generator 140 and may control regulating device(s) 114 based on supply voltage at supply node 121 and based on the reference voltage.

Error sensor 112 for one embodiment may sense error in supply voltage at supply node 121 based on the reference voltage. Error sensor 112 for one embodiment may compare a voltage corresponding to supply voltage at supply node 121 to a voltage corresponding to the reference voltage generated by reference voltage generator 140 to sense error in supply voltage at supply node 121. Error sensor 112 for one embodiment may compare supply voltage at supply node 121 or a voltage derived from supply voltage at supply node 121 to the reference voltage from reference voltage generator 140 or a voltage derived from the reference voltage and substantially sense the difference between such compared signals to sense error.

Error sensor 112 for one embodiment may be coupled to control regulating device(s) 114 based on the sensed error. Error sensor 112 for one embodiment may generate one or more control signals based on the sensed error to control regulating device(s) 114. Error sensor 112 for one embodiment may generate a control signal representative of the sensed error. Error sensor 112 for one embodiment may generate one or more amplified analog control signals representative of the sensed error.

Error sensor 112 for one embodiment may be coupled to control regulating device(s) 114 based on the sensed error to help maintain at supply node 121 a supply voltage of a suitable level relative to the reference voltage. Reference voltage generator 140 for one embodiment may generate the reference voltage at any suitable level to help error sensor 112 control regulating device(s) 114 to help supply substantially the first target supply voltage at supply node 121. The reference voltage for one embodiment may be substantially equal to the first target supply voltage. Reference voltage generator 140 for one embodiment may generate a relatively constant reference voltage. Although illustrated on integrated circuit 100 for one embodiment, reference voltage generator 140 for another embodiment may be external to integrated circuit 100.

Supply voltage regulator 110 for one embodiment may include one or more power devices 118 to couple supply node 121 to supply node 117 when circuit 120 is in the second predetermined operational state. Supply voltage regulator 110 for one embodiment may use power device(s) 118 to help supply substantially the second target supply voltage at supply node 121 when circuit 120 is in the second predetermined operational state, such as an active state for example.

Supply voltage regulator 110 for one embodiment may use regulating device(s) 114 and load device(s) 116 to supply a supply voltage at supply node 121 and may use power device(s) 118 to decouple supply node 121 from supply node 117 when circuit 120 is in the first predetermined operational state, such as an inactive state for example. Supply voltage regulator 110 for one embodiment may use power device(s) 118 and load device(s) 116 to supply a supply voltage at supply node 121 and may use regulating device(s) 114 to decouple supply node 121 from supply node 113 when circuit 120 is in the second predetermined operational state, such as an active state for example.

When circuit 120 transitions from the second predetermined operational state to the first predetermined operational state, using power device(s) 118 to decouple supply node 121 from supply node 117 for one embodiment may initially allow supply voltage across circuit 120 to decrease. Error sensor 112 for one embodiment may then control regulating device(s) 114 to help maintain supply voltage at supply node 121 from exceeding substantially the first target supply voltage. Error sensor 112 for one embodiment may be considered to control regulating device(s) 114 to help effectively brake supply voltage at supply node 121 from exceeding substantially the first target supply voltage.

When circuit 120 transitions from the first predetermined operational state to the second predetermined operational state, using power device(s) 118 to couple supply node 121 to supply node 117 for one embodiment may increase supply voltage across circuit 120 and cause error sensor 112 to control regulating device(s) 114 to decouple supply node 121 from supply node 113.

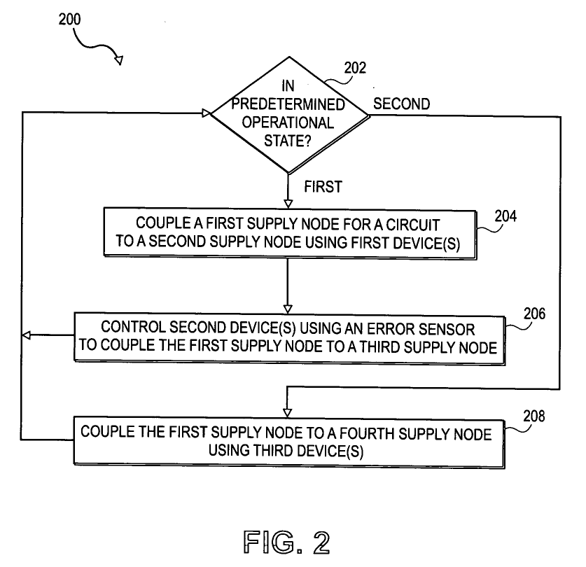

Supply voltage regulator 110 for one embodiment may operate in accordance with a flow diagram 200 of FIG. 2.

When for block 202 circuit 120 is in a first predetermined operational state, such as an inactive state for example, supply node 121 for block 204 may be coupled to supply node 113 using regulating device(s) 114 and to supply node 115 using load device(s) 116. Regulating device(s) 114 for block 206 may be controlled using error sensor 112. Error sensor 112 for one embodiment may control regulating device(s) 114 based on supply voltage at supply node 121 and based on a reference voltage.

When for block 202 circuit 120 is in a second predetermined operational state, such as an active state for example, supply node 121 for block 208 may be coupled to supply node 117 using power device(s) 118.

Operations for blocks 202-208 for one embodiment may be repeated for subsequent placement(s) of circuit 120 in the first and/or second predetermined operational states.

Supply voltage regulator 110 may perform operations for blocks 202-208 in any suitable order and may or may not overlap in time the performance of any suitable operation with any other suitable operation.

Example Circuitry for Supply Voltage Regulator

Error sensor 112, regulating device(s) 114, load device(s) 116, and power device(s) 118 may include any suitable circuitry to help control supply voltage at supply node 121.

Error sensor 112 for one embodiment may include any suitable error amplifier, such as an operational amplifier (opamp) for example.

Regulating device(s) 114, load device(s) 116, and power device(s) 118 for one embodiment may include any suitable switching circuitry.

Regulating device(s) 114 for one embodiment may include any suitable one or more transistors, such as suitable field effect transistor(s) (FET(s)) for example, coupled to help couple supply node 121 to supply node 113. Error sensor 112 for one embodiment may be coupled to control one or more such transistor(s) to selectively couple supply node 121 to supply node 113.

Load device(s) 116 for one embodiment may include any suitable one or more transistors, such as suitable field effect transistor(s) (FET(s)) for example, coupled to help couple supply node 121 to supply node 115. For one embodiment, any suitable signal source may be coupled to control one or more such transistor(s) to couple supply node 121 to supply node 115.

Power device(s) 118 for one embodiment may include any suitable one or more transistors, such as suitable field effect transistor(s) (FET(s)) for example, coupled to help couple supply node 121 to supply node 117. Controller 130 for one embodiment may be coupled to control one or more such transistor(s) to selectively couple supply node 121 to supply node 117.

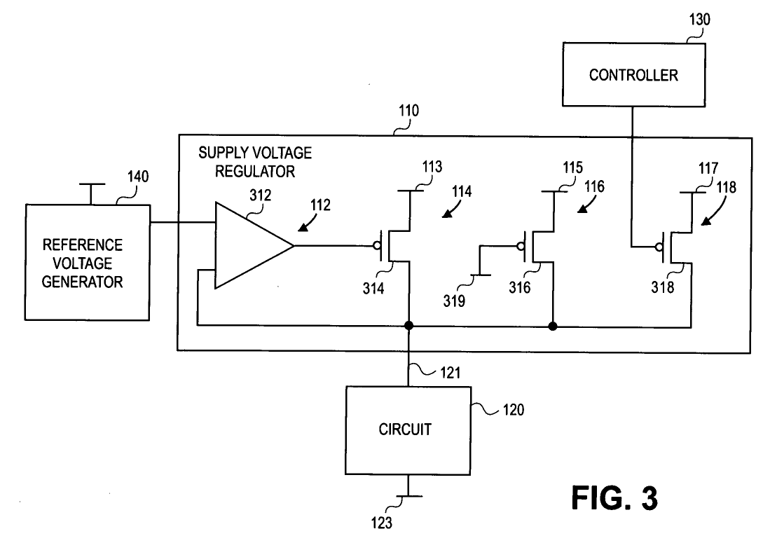

FIG. 3 illustrates, for one embodiment, circuitry for supply voltage generator 110 to supply at supply node 121 a supply voltage higher than supply voltage at supply node 123. As illustrated in FIG. 3, error sensor 112 may include an error amplifier 312, regulating device(s) 114 may include a p-channel field effect transistor (pFET) 314, load device(s) 116 may include a pFET 316, and power device(s) 118 may include a pFET 318.

Error amplifier 312 may be coupled to control pFET 314 to selectively couple supply node 121 to supply node 113 based on supply voltage at supply node 121 and based on a reference voltage to control supply voltage at supply node 121. A suitable supply node 319, such as a ground supply node for example, may be coupled to activate pFET 316 to couple supply node 121 to supply node 115. Controller 130 may be coupled to selectively activate and deactivate pFET 318 to selectively couple supply node 121 to supply node 117 based on an operational state of circuit 120.

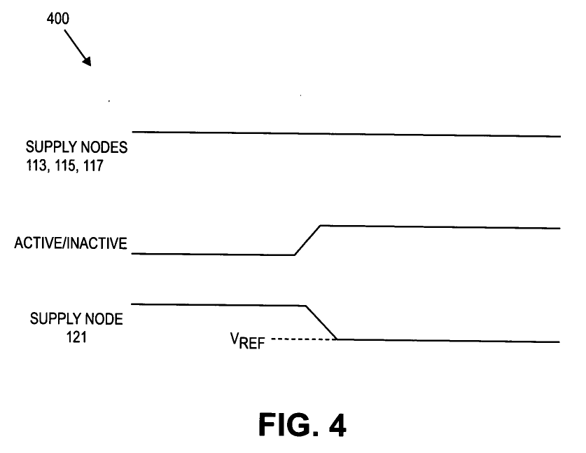

FIG. 4 illustrates, for one embodiment, an example, although relatively crude, timing diagram 400 for the example circuitry of FIG. 3.

With reference to both FIGS. 3 and 4, controller 130 may assert an active control signal when circuit 120 is in an active state to activate pFET 318 to couple supply node 121 to supply node 117. The pFET 316 may also remain activated to couple supply node 121 to supply node 115. The pFETs 316 and 318 may then together help supply an operating supply voltage across circuit 120. The pFETs 316 and 318 for one embodiment may help supply substantially a second target supply voltage at supply node 121 greater than a first target supply voltage to be supplied through control of pFET 314 by error amplifier 312 when circuit 120 is in an inactive state. Error amplifier 312 may therefore deactivate pFET 314 to decouple supply node 121 from supply node 113 when circuit 120 is in the active state.

When circuit 120 transitions to an inactive state, controller 130 may assert an inactive control signal to deactivate pFET 318 to decouple supply node 121 from supply node 117, allowing supply voltage at supply node 121 to fall. Although still activated, pFET 316 for one embodiment may be sized to allow supply voltage at supply node 121 to fall below the first target supply voltage to be supplied when circuit 120 is in an inactive state. As supply voltage at supply node 121 falls, error amplifier 312 may control pFET 314 to help maintain supply voltage at supply node 121 from falling below substantially the first target supply voltage. Error amplifier 312 may be considered to control pFET 314 to help effectively brake supply voltage at supply node 121 from falling below the first target supply voltage. Because error amplifier 312 and pFET 314 form a feedback control loop to help supply substantially the first target supply voltage at supply node 121 based on a reference voltage, error amplifier 312 and pFET 314 inherently compensate for process, voltage, and/or temperature (PVT) variations with pFET 316, for example.

When circuit 120 transitions to an active state, controller 130 may assert an active control signal to activate pFET 318 to couple supply node 121 to supply node 117 to thereby deactivate pFET 314 to decouple supply node 121 from supply node 113. Activating pFET 318 to couple supply node 121 to supply node 117 for one embodiment may help supply substantially the second target supply voltage at supply node 121 relatively quickly.

The pFET 316 for one embodiment may supply a relatively low impedance path to supply node 115 to help reduce supply voltage at supply node 121 when circuit 120 is in the inactive state. The pFET 316 for one embodiment may therefore help allow the feedback control loop formed by error amplifier 312 and pFET 314 to be designed, for example, without having to be heavily or over damped in order to settle with reduced or minimized concern for undershoots. For one embodiment, this may help allow supply voltage regulator 110 to be relatively small in size. Small-sized supply voltage regulators similar to supply voltage regulator 110 for one embodiment may be more suitable for use in multiple locations of integrated circuit 100.

The pFET 316 for one embodiment, as illustrated in FIG. 3, may remain activated when circuit 120 is in the active state to help maintain the feedback control loop formed by error amplifier 312 and pFET 314, helping to activate and deactivate error amplifier 312 relatively quickly. Activating pFET 316 when circuit 120 is in the active state for one embodiment may also help allow a smaller-sized pFET 318 to be used and therefore help avoid use of a larger-sized power FET and/or a higher supply voltage.

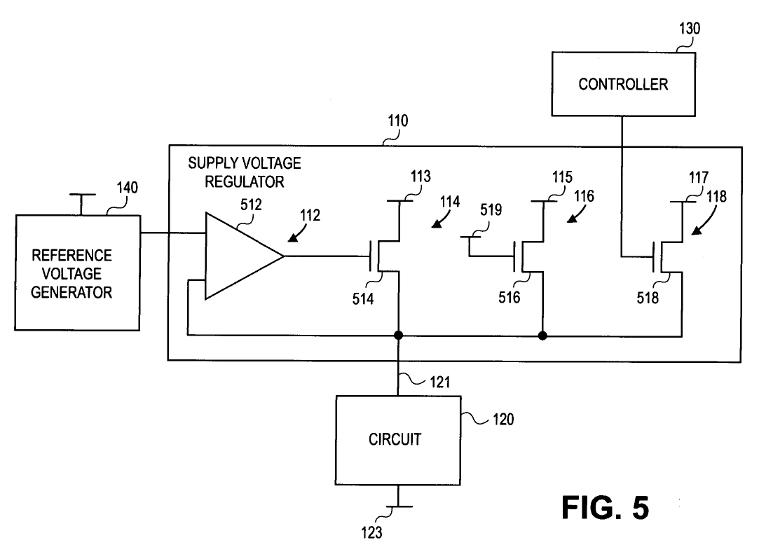

FIG. 5 illustrates, for one embodiment, circuitry for supply voltage generator 110 to supply at supply node 121 a supply voltage lower than supply voltage at supply node 123. As illustrated in FIG. 5, error sensor 112 may include an error amplifier 512, regulating device(s) 114 may include a n-channel field effect transistor (nFET) 514, load device(s) 116 may include a nFET 516, and power device(s) 118 may include a nFET 518.

Error amplifier 512 may be coupled to control nFET 514 to selectively couple supply node 121 to supply node 113 based on supply voltage at supply node 121 and based on a reference voltage to control supply voltage at supply node 121. A suitable supply node 519, such as a suitable positive voltage supply node for example, may be coupled to activate nFET 516 to couple supply node 121 to supply node 115. Controller 130 may be coupled to selectively activate and deactivate nFET 518 to selectively couple supply node 121 to supply node 117 based on an operational state of circuit 120.

With reference to FIG. 5, controller 130 may assert an active control signal when circuit 120 is in an active state to activate nFET 518 to couple supply node 121 to supply node 117. The nFET 516 may also remain activated to couple supply node 121 to supply node 115. The nFETs 516 and 518 may then together help supply an operating supply voltage across circuit 120. The nFETs 516 and 518 for one embodiment may help supply substantially a second target supply voltage at supply node 121 less than a first target supply voltage to be supplied through control of nFET 514 by error amplifier 512 when circuit 120 is in an inactive state. Error amplifier 512 may therefore deactivate nFET 514 to decouple supply node 121 from supply node 113 when circuit 120 is in the active state.

Controller 130 may assert an inactive control signal when circuit 120 is in an inactive state to deactivate nFET 518 to decouple supply node 121 from supply node 117, allowing supply voltage at supply node 121 to rise. The nFET 516 for one embodiment may be sized to allow supply voltage at supply node 121 to rise above the first target supply voltage to be supplied when circuit 120 is in an inactive state. As supply voltage at supply node 121 rises, error amplifier 512 may control nFET 514 to help maintain supply voltage at supply node 121 from rising above substantially the first target supply voltage. Error amplifier 512 may be considered to control nFET 514 to help effectively brake supply voltage at supply node 121 from rising above the first target supply voltage.

Example System

Supply voltage regulator 110 may be used to help control supply voltage for any suitable circuitry on any suitable integrated circuit. Supply voltage regulator 110 for one embodiment may be used to help control supply voltage for one or more memory cells of any suitable memory, such as a static random access memory (SRAM) for example. Such memory for one embodiment may comprise multiple supply voltage regulators similar to supply voltage regulator 110 to separately control supply voltage for corresponding portions having one or more memory cells of such memory. Supply voltage regulator 110 for one embodiment may be used to help supply an operational supply voltage across one or more memory cells to power such memory cell(s) when such memory cell(s) are in an active state and to help supply a reduced supply voltage across such memory cell(s) when such memory cell(s) are in an inactive state.

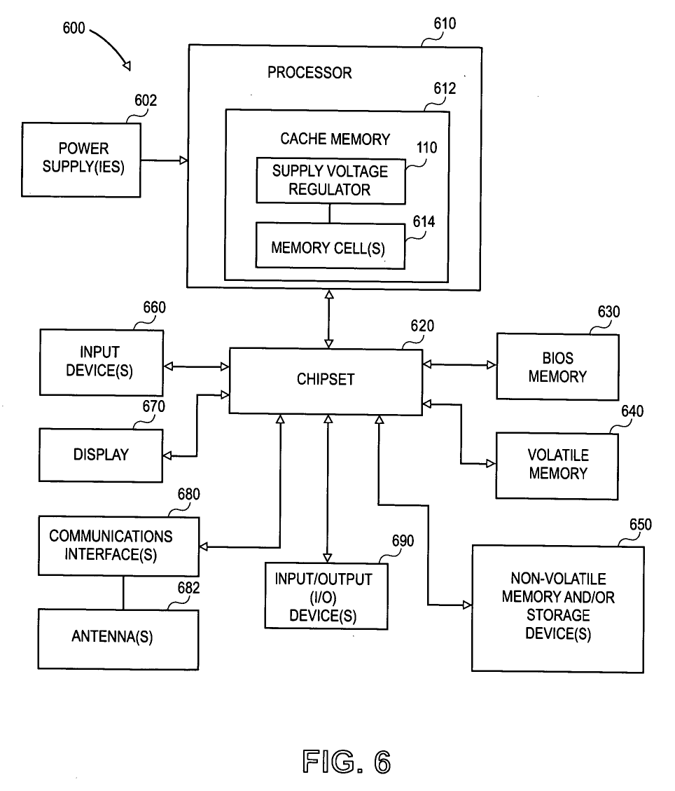

A memory having supply voltage regulator 110 may be used for any suitable purpose in any suitable system such as, for example, for cache memory 612 in a processor 610 of a system 600 of FIG. 6.

As illustrated in FIG. 6, system 600 for one embodiment may comprise processor 610 having cache memory 612 including supply voltage regulator 110 to control supply voltage for one or more memory cells 614 of cache memory 612. Although illustrated as a part of processor 610 for one embodiment, cache memory 612 for another embodiment may be separate from processor 610. Cache memory 612 for one embodiment may be on an integrated circuit separate from processor 610. System 600 for another embodiment may include multiple processors one or more of which may have cache memory similar to cache memory 612.

Processor 610 for one embodiment may be coupled to receive power from one or more power supplies 602 to generate supply voltage(s) for supply voltage generator 110. Power supply(ies) 602 for one embodiment may correspond to power supply(ies) 102 of FIG. 1.

System 600 for one embodiment may also include a chipset 620 coupled to processor 610, a basic input/output system (BIOS) memory 630 coupled to chipset 620, volatile memory 640 coupled to chipset 620, non-volatile memory and/or storage device(s) 650 coupled to chipset 620, one or more input devices 660 coupled to chipset 620, a display 670 coupled to chipset 620, one or more communications interfaces 680 coupled to chipset 620, and/or one or more other input/output (I/O) devices 690 coupled to chipset 620.

Chipset 620 for one embodiment may include any suitable interface controllers to provide for any suitable communications link to processor 610 and/or to any suitable device or component in communication with chipset 620.

Chipset 620 for one embodiment may include a firmware controller to provide an interface to BIOS memory 630. BIOS memory 630 may be used to store any suitable system and/or video BIOS software for system 600. BIOS memory 630 may include any suitable non-volatile memory, such as a suitable flash memory for example. BIOS memory 630 for one embodiment may alternatively be included in chipset 620.

Chipset 620 for one embodiment may include one or more memory controllers to provide an interface to volatile memory 640. Volatile memory 640 may be used to load and store data and/or instructions, for example, for system 600. Volatile memory 640 may include any suitable volatile memory, such as suitable dynamic random access memory (DRAM) for example. Processor 610 for one embodiment may use cache memory 612 to store data and/or instructions stored or to be stored in volatile memory 640, for example, for faster access to such data and/or instructions.

Chipset 620 for one embodiment may include a graphics controller to provide an interface to display 670. Display 670 may include any suitable display, such as a cathode ray tube (CRT) or a liquid crystal display (LCD) for example. The graphics controller for one embodiment may alternatively be external to chipset 620.

Chipset 620 for one embodiment may include one or more input/output (I/O) controllers to provide an interface to non-volatile memory and/or storage device(s) 650, input device(s) 660, communications interface(s) 680, and/or I/O devices 690.

Non-volatile memory and/or storage device(s) 650 may be used to store data and/or instructions, for example. Non-volatile memory and/or storage device(s) 650 may include any suitable non-volatile memory, such as flash memory for example, and/or may include any suitable non-volatile storage device(s), such as one or more hard disk drives (HDDs), one or more compact disc (CD) drives, and/or one or more digital versatile disc (DVD) drives for example.

Input device(s) 660 may include any suitable input device(s), such as a keyboard, a mouse, and/or any other suitable cursor control device.

Communications interface(s) 680 may provide an interface for system 600 to communicate over one or more networks and/or with any other suitable device. Communications interface(s) 680 may include any suitable hardware and/or firmware. Communications interface(s) 680 for one embodiment may include, for example, a network adapter, a wireless network adapter, a telephone modem, and/or a wireless modem. For wireless communications, communications interface(s) 680 for one embodiment may use one or more antennas 682.

I/O device(s) 690 may include any suitable I/O device(s) such as, for example, an audio device to help convert sound into corresponding digital signals and/or to help convert digital signals into corresponding sound, a camera, a camcorder, a printer, and/or a scanner.

Although described as residing in chipset 620, one or more controllers of chipset 620 may be integrated with processor 610, allowing processor 610 to communicate with one or more devices or components directly. As one example, one or more memory controllers for one embodiment may be integrated with processor 610, allowing processor 610 to communicate with volatile memory 640 directly.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
a circuit coupled to a first supply node to power the circuit; and
a supply voltage regulator to control voltage at the first supply node, the supply voltage regulator including one or more first devices to couple the first supply node to a second supply node when the circuit is in a predetermined operational state and including an error sensor to control the one or more first devices,
the supply voltage regulator including one or more second devices to couple the first supply node to a third supply node when the circuit is in the predetermined operational state.

2. The apparatus of claim 1, wherein the regulator includes one or more third devices to couple the first supply node to a fourth supply node when the circuit is in another predetermined operational state.

3. The apparatus of claim 2, wherein the one or more third devices are to decouple the first supply node from the fourth supply node when the circuit is in the predetermined operational state.

4. The apparatus of claim 1, wherein the predetermined operational state is an inactive state.

5. The apparatus of claim 2, wherein the other predetermined operational state is an active state.

6. The apparatus of claim 1, wherein the error sensor is to control the one or more first devices based on a voltage at the first supply node and based on a reference voltage.

7. The apparatus of claim 1, wherein the second supply node and the third supply node are the same node.

8. The apparatus of claim 2, wherein the second supply node, the third supply node, and the fourth supply node are the same node.

9. The apparatus of claim 1, wherein the circuit includes one or more memory cells.

10. The apparatus of claim 1, wherein the second supply node is a positive voltage supply node.

11. The apparatus of claim 1, wherein the second supply node is a ground node.

12. The apparatus of claim 1, wherein the one or more first devices include a transistor.

13. The apparatus of claim 1, wherein the one or more second devices include a transistor.

14. The apparatus of claim 2, wherein the one or more third devices include a transistor.

15. A method comprising:
coupling a first supply node for a circuit to a second supply node using one or more first devices when the circuit is in a predetermined operational state; and
controlling one or more second devices using an error sensor to couple the first supply node to a third supply node when the circuit is in the predetermined operational state.

16. The method of claim 15, comprising coupling the first supply node to a fourth supply node using one or more third devices when the circuit is in another predetermined operational state.

17. The method of claim 15, wherein the controlling includes controlling one or more second devices using the error sensor based on a voltage at the first supply node and based on a reference voltage.

18. A system comprising:
volatile memory; and
a processor having a cache memory including a circuit coupled to a first supply node, the cache memory including a supply voltage regulator to control voltage at the first supply node,
the supply voltage regulator including one or more first devices to couple the first supply node to a second supply node when the circuit of the cache memory is in a predetermined operational state and including an error sensor to control the one or more first devices,
the supply voltage regulator including one or more second devices to couple the first supply node to a third supply node when the circuit of the cache memory is in the predetermined operational state.

19. The system of claim 18, wherein the regulator includes one or more third devices to couple the first supply node to a fourth supply node when the circuit of the cache memory is in another predetermined operational state.

20. The system of claim 18, wherein the error sensor is to control the one or more first devices based on a voltage at the first supply node and based on a reference voltage.
